(19) United States
(12) Patent Application Publication
(10) Pub. No.: US 2022/0128031 A1
(43) Pub. Date: Apr. 28, 2022

(54) Air- Powered Portable Mobile Generator

(71) Applicant: Hadi Sultan, Pembroke Pines, FL (US)

(72) Inventor: Hadi Sultan, Pembroke Pines, FL (US)

(21) Appl. No.: 17/079,651

(22) Filed: Oct. 26, 2020

(51) Int. Cl. F03D 9/25; F03D 9/30

(52) U.S. Cl. CPC F03D 9/25; H02J 2300/28; F03D 9/30

(57) ABSTRACT

A hand-held portable mobile device, and a method of use, to generate electricity to charge mobile devices, such as smart phones, by using the kinetic energy of the user's own exhaling air or a manual pump. The device consists of two units; a blowing tube unit and a coupling generator unit. The generator unit include a mechanical part and an electrical part. The mechanical part comprises a freely spinning hollow shaft driven by the force of the user's exhaled air entering into the shaft and then exiting the shaft from narrow orifices of multiple L-shaped pipes configured on the shaft so that the forceful exit of the air from the pipes creates a reactional force that causes the hollow shaft to rotate rapidly. The speed of the shaft's rotation is then further augmented by coupling gears. The rotational force is transmitted to the rotor of a coupling DC generator inside the housing of the generator unit. The electricity thus produced by the generator can be directly delivered to a connected mobile device to be charged via power outlet. In another preferred embodiment, the produced electricity can be stored in coupling capacitor and/or internal battery incorporated within the generator unit. The apparatus further includes a pressure regulator to limit the air pressure entering the device and a second electric regulator to prevent overcharging.

### BACKGROUND OF THE INVENTION

### 1—Field of the Invention

The present invention generally relates to free energy portable power generator, and more specifically to a device used for generating electricity to charge portable devices using the user's own expiratory force or a manual pump.

### 2—Description of Prior Art

Mobile devices became an essential part of our life. The average US. adult will spend 2 hours, 55 minutes on a smartphone in 2019, a 9-minute increase from 2018. Among smartphone users in the US, time spent with their device is 3 hours, 10 minutes per day. Mobile devices are not only essential for our wellbeing, but they are essential for our safety as well.

Although source of electricity, to charge a mobile device, is readily available in most of the times, there are times when source of electricity is not available, such as power outage after natural disasters; like hurricane, tornado or earthquake. Power outage may occur after terror attack or war or during ordinary maintenance to the power station. Source of electricity may not be available during long outdoor activities in the wilderness such as hiking, camping, Rock climbing, mountaineering, cycling, and horse riding. Our safety can sometimes be dependent on the smart devices and on the availability of power sources to keep these smart devices functioning and charged all times.

Many inventors tried to overcome this problem by inventing and disclosing several types of devices generating electricity by manual power such as crank, pulling a spring, using external fan to capture the wind power, pendulum motion energy, shaking energy, and solar panels.

In his US patent No; U.S. Pat. No. 9,099,892 B2, dated 8 Apr. 2015, Glenn Jakins describes a power system includes a battery that can be charged from an AC power and a second charge input configurated to receive a charge from a DC power source such as a solar panel or a hand crank generator.

Wen-Ching Lai, in his US patent application publication No. US 2012/0212067 A1, date Aug. 23, 2012, describes a power complex power supply apparatus for supplying electric power using a hand crank, external, wind power generator via a foldable stand and blades, and solar panel.

Becker, in his patent No. U.S. Pat. No. 6,914,340 B2, dated Jul. 5, 2005, describes a handheld portable generator operated by a hand crank.

Feng Tian Peng, in his patent TW1494506B, Aug. 11, 2010, describes a hand crank generator device.

Japanese patent No. JP3160205U describes generator having an electrical output terminal and an input shaft for receiving mechanical power.

Chinese patent No. CN202888939U, issued Apr. 17, 2013, describes a spring-powered portable power supply using a crank.

Chinese patent CN101510626A, dated Aug. 19, 2009 describes a portable charger manually activated by manually pulling a tractive member. See also patent No. CN2606485y dated 3 Oct. 2004.

Monostory in his U.S. Pat. No. 8,146,219 B2, dated 4 Mar. 2012, describes a small wind turbine affixed to a telescopic mast that generates power to a battery system.

Chen, in his U.S. Pat. No. 7,339,286 B1 dated 5 Apr. 2008, describes a portable wind power generator.

Tu-Ta Tu, in his patent No. U.S. Pat. No. 6,978,161 B2, dated Dec. 20, 2005, describes a self-rechargeable portable telephone device in which electricity is generated by movements made in any direction, includes an eccentric pendulum transmission device which causes rotation of an output shaft in response to movement of the telephone body.

Bailey, in his US patent publication application No. 2006/0139000 A1, dated Jun. 29, 2006, describes a wrist worn battery charging system is disclosed which may be utilized to power or charge the batteries of portable devices, such as wrist worn PDA's, wrist worn Cell-Phones, wrist worn PC's, wrist worn walkie-talkies, wrist worn MP3 players, or other electronic devices which are battery powered and worn on the body of the user. The battery charger operates by turning the motion of the user's arm into electrical energy by the action of a miniature D.C. generator.

A Korean patent No. KR20120035281A, dated Apr. 16, 2012 describes a power generation device using the rotational force generated by the high-pressure compressed air, a compressor for generating the compressed air as part of the generated drive current By maximizing the energy efficiency by driving the electric vehicle, as well as providing a power generation device that can be usefully used for electric devices and facilities that require electricity, such as electric power sources of ships, boilers, power plants and homes.

All the above-mentioned patents are less than adequate and does not meet all the requirements for low cost, efficiency, practicality and ease of use.

The current invention provides an endless number of recharging anytime, anywhere. The need for this device in the wilderness and in emergency situations cannot be more emphasized.

Some of the advantages of the present invention is its easy assembly, low cost manufacturing, easy use, rapid charging, highly efficient and cost-effective power source, more reliable and probably less expensive than a spare rechargeable battery.

Furthermore, the current invention provides a portable and low weight compact life-saving device in emergency situation during prolonged outdoor activities such as camping, mountain-climbing and other outdoor activities when the battery of the mobile device dies. It is a useful personal device for soldiers during a war mission in the wilderness.

The objects, features and advantages of the present invention will become more apparent from the following detailed description.

### SUMMARY OF THE INVENTION

The current invention makes it possible to a person to charge his mobile device anywhere without the need for any power source. The invention is consisted of two units; the blowing tune (BT), and the generator unit. The user can create electricity while blowing a tube in the same way he plays the flute.

The blowing tube has a proximal section, preferably detachable, a conducting tube, and a distal section adapted to be attached to the generator unit. The blowing tube in the preferred embodiment is detachable from the generator unit.

The proximal section of the blowing tube (BT) is the largest part of the tube to allow easy blowing. In the preferred embodiment, this segment includes a filtering component to prevent dust and moisture entering the system. In other embodiment, this section can be configured to adapt a manual pump to push the air.

Furthermore, this proximal segment, also, contains a pressure valve to prevent excessive air pressure delivered to the charger. The valve will open up when the pressure inside the tube exceeds the allowed pressure.

The filter and the valve are preferably included in this proximal segment; however, they can be placed in any portion of the blowing tube. The proximal segment is preferably detachable from the rest of the BT for lower cost replacement when needed. Exhaled or manually pumped air will be pushed into the inlet of the second unit when both units are connected.

The second unit comprises a housing with indicator on its wall showing the charging level. The housing is configured with vents to allow air exit. The housing contains all the other components of the device. The main components of this unit are a spinner, gears, DC generator, capacitor, on/off controller, and microprocessor.

A spinner is made up of a hollow shaft with open proximal end receiving the incoming air. The other end of the shaft is blind. The spinner is configured to have multiple L-shaped pipes extended from the hollow shaft along its axis and its cross section. The pipes are in direct communication with the shaft's inner space proximally and having narrow opening distally.

As the forced air enters the hollow shaft and exits through the distal pipes' narrow orifices, reactional forces are created causing the hollow shaft to spin rapidly, several hundred RPM (Rotations Per Minute).

In the preferred embodiment, the hollow shaft spins around its long axis inside low friction rings.

A toothed wheel is attached to the distal end of the shaft. The attached toothed wheel transmits the torque to one or more other multiple toothed wheels, thereby augmenting the rotational speed from hundreds RPM to thousands RPM. The resultant high rotational speed from the gear is transmitted via a free moving high-speed solid shaft to the rotor of a DC generator.

The produced electricity can be transferred directly to the mobile device to be charged via an outlet in the housing of the generator unit or can be stored in capacitor, or in rechargeable battery, such as NiCd, NiMH, Won, and Li-pol, incorporated in the generator unit.

The generator unit also includes electricity controller to automatically disconnects the charging process once the capacitor and/or the battery are fully charged. Furthermore, the charger includes a microprocessor to regulate the inner function of the device such as the charging display and any other additional features that may be added, such as LCD flashlight.

### BRIEF DESCRIPTION OF THE DRAWINGS

FIG. 1 is a schematic view of using the invention; showing the blowing tube (101) connected to the generator unit (102) which in turns is connected to a mobile device (105).

FIG. 2 is schematic view of the main components of the preferred embodiment of the generator unit.

FIG. 3 is a schematic side view of the spinner

FIG. 4A is a schematic cross section view of the spinner with 180, 90, and 120-degree positions of the L-shaped pipes.

FIG. 4B is a schematic view of the components of the connection between the generator unit and the distal end of the blowing tube.

FIG. 5 is a schematic view of the different segments of the blowing tube showing the proximal segment containing a filter and a pressure regulating valve, the body segment and its distal segment.

### DETAILED DESCRIPTION OF THE PREFERRED EMBODIMENTS OF THE INVENTION

The current invention enables a user to charge his mobile device anywhere without the need for any power source. The new invention allows the user to use his breathing air to charge the mobile device in a very simple and efficient method as simple as inflating a balloon. The device comprising two units; a blowing tube and a generator unit. The two parts are separable and can be connected to each other during the charging process.

Similar to thousands of other inventions in this field, this invention is functionally composed of two main parts, mechanical component and electrical component.

Only a brief description of the electrical components will be described here since the assembly of these electrical components and how they work together is very well known to the ordinary person in the art. Furthermore, the assembly of most of the generators currently existing in the market consists of identical parts and components.

On the other hand, since different generators vary among each other mainly by their mechanical component, a detailed description of the mechanical component of this invention will be described here. This mechanical component made this invention distinct and unique in its assembly and in its functionality.

Mechanical energy that produced electricity, and how this mechanical energy is produced, is the main differentiating part among thousands different invention in this field. Mechanical energy had been historically produced by harvesting the potential and kinetic energy from running water, wind, coal, gas and diesel, tidal and wave power and nuclear fusion. The mechanical energy thus produced is in turn converted to electrical energy using the principle of the generator first described in 1831 by Michael Faraday.

The key component of the current invention is its unique innovative design in producing the mechanical energy needed to generale electricity. Contrary to all currently invented devices, the mechanical energy in this invention is produced by air power driving a freely rotating hollow shaft to spin in response to air exiting its shaft. AH other generators use the wind, gas, and water energy to externally drive a wheel or to externally drive the blades of a fan or the blades of a turbine. The efficiency of external power driving blades of fans or turbine is extremely low compared to the efficiency of internally acting force of the air as it is described in this current invention. The kinetic energy of the whole air blown into the device is converted to a mechanical energy and subsequently into electric energy.

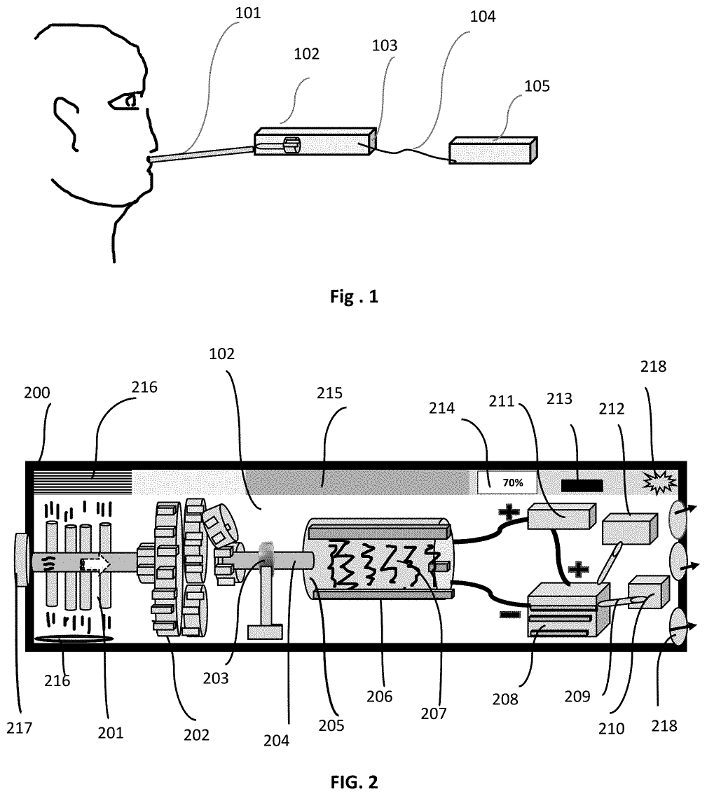

FIG. 1 illustrate the gross use of the device in the preferred embodiment. Similar to using a flute, the user places the blowing tube 101 in his mouth and normally exhales. The exhale is repeated several times until the indicator on the charger 102 shows that the device is fully or adequately charged. Once the charger is adequately charged, or during the charging process, a mobile device 105 that need to be charged is connected to the charger by an appropriate cable 104. In another embodiment, the blowing tube is attached to a manual pump.

FIG. 2 illustrates the components of the charger 102. The figure illustrates the general components of the invention.

A housing 200 made of any appropriate material such as aluminum, copper, hard carbon fibers, hard plastic, or any other material used in manufacturing similar devices. The housing has an air inlet 217. The inlet is designed to make air-tight connection between the charger 102 and the blowing tube 101. The inlet will allow the air to enter into the shaft 301 of a spinner 201 to generate a spinning force. The inlet and the spinner will be described in more details below.

A spinner 201 connected to gear box 202 transmits the rotational force to a solid free-moving high-speed shaft 204 which is connected to a generator 205. The rotor 206 driven by the high-speed shaft rotates around a stator 205. The capacitor 208 and the rechargeable battery 210 are connected to each other and to an electric regulator 211. The electric regulator turns off the charging process if the device is full, even though the generator is still spinning.

A microprocessor 212 is a circuit which regulate all the functions of the device including displaying 214 the level of charging, additional LED flashlight 218. A switch 213 can be used to manually turns off the charging process even if air is blown into the unit.

The housing 200 has one or more outlet 218. The outlet matches the plug of the cable of the mobile device 104. Furthermore, the housing has at least one vent 216 to allow the escape of the injected air and to cool the components.

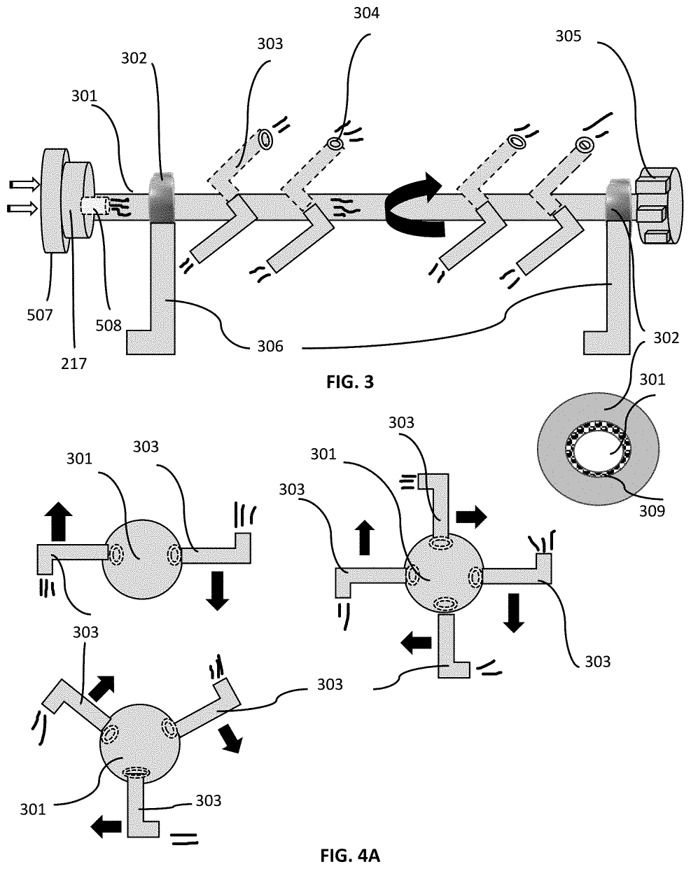

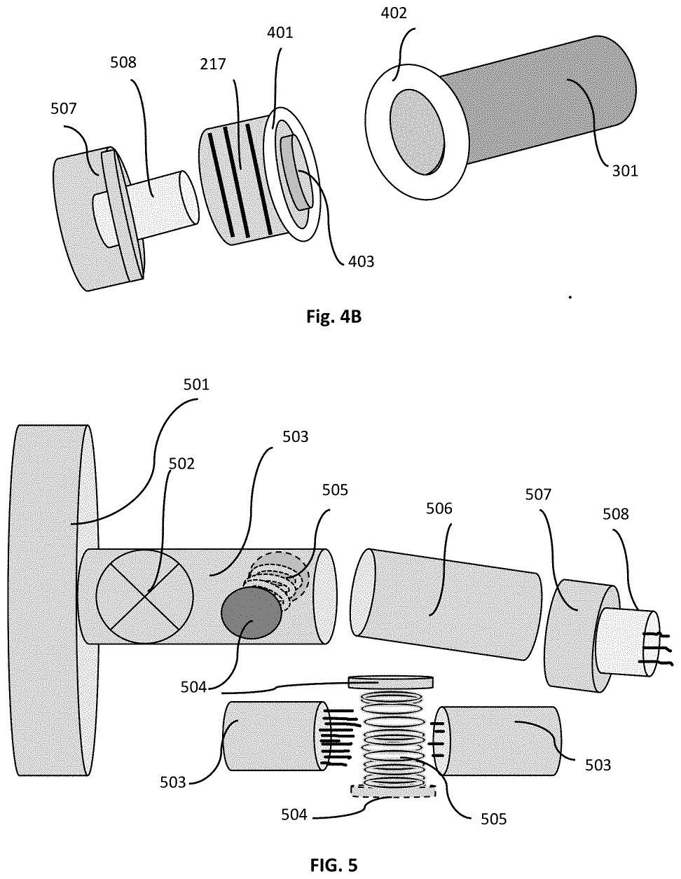

FIG. 3 and FIG. 4A illustrate the components and the function of the spinner 201. The spinner is preferably made of a material which has low friction coefficient, light weight and durable. Steel or Aluminum can be used. However, any other low friction coefficient alloy can be used.

The shaft 301 of the spinner is hollow and configured to have several L-shaped pipes 303 extended from its shaft. The proximal segment of the L-Shaped pipe is perpendicular to the main axis of the shaft, and the distal segment of the L-shaped pipe is in the same plain and parallel to the cross section of the shaft. The distal segment is preferably made narrower towards its end where the orifice 304 is located. This will allow the shaft to spin in the opposite direction to the air exit from the orifice. The shaft 301 spins around its axis inside a low friction fitted bracelets 302. In other embodiment the shaft spins inside ball bearing wheels 309. The bracelets 302 are stabilized on supporting structure 306 to prevent instability.

At each cross section of the shaft 301, In the preferred embodiment, the L-shaped pipes 303 are be positioned at 90-degree, 120-degree or 180-degree. The higher the number of pipes along the long axis of the shaft, the higher the rotational speed. Number of pipes and their angles can vary with each specific product depends on the manufacturing preference in view of efficiency and cost of production.

The air enters the pipe shaft 301 via the nostril 508 of the distal segment 507 of the blowing tube 101. When connected, the nostril 508 should be in the center of the shaft and should not be in contact with the inner wall of the shaft. The distal end 507 allows an air-tight contact with the air inlet 217 which will be described below.

The pipe shaft 301 has a blind distal end with a solid part carrying on its outside a toothed wheel 305. This wheel 305 spins at the same speed as the shaft.

FIG. 4 B illustrate the distal segment 507 of the blowing tube 101 and its nostril 508. The drawing also illustrates the air inlet 217. The air inlet 217 is a non-removal part of the housing 200 and makes an air-tight fitting with the proximal end of the hollow shaft 301 by using a build-in matching sealing rings 401 and 402. The nostril 508 pass the inlet through a matching opening 403 in the inlet. The distal segment 507 is connected to the air inlet and secured by screw mechanism, by clicking mechanism, by special configuration of 507 such as making 507 slightly conical in shape, or any other known design to achieve secure and air-tight sealing between the distal end 507 and the air inlet 217.

FIG. 5 illustrate the blowing tub (BT) 101. The BT consist of a narrow conducting tube 506 with proximal and distal ends. The tube 506 is preferably about 10 mm in diameter made of any suitable material impermeable to air such as rubber, plastic, wood or metal. The proximal segment in the preferred embodiment is detachable. The proximal end however can be an integral non-detachable part of the tube 506.

The proximal segment is made of mouthpiece 501 to be put in the user's mouth to inflate the device. The mouthpiece is preferably made of hard material and about 1-2 cm in diameter. The mouthpiece has a distal end 503 connected, or to be connected if detachable, to the 506.

The proximal segment preferably includes a filter 502 to prevent dust, saliva, water and unwanted particles from entering the device.

The proximal segment in the preferred embodiment includes a pressure regulating valve 504 to opens up when the air pressure exceeds a preset level. This valve limits the excessive air force which may damage the device. Any type of valve available in the market can be used.

In the preferred embodiment, the valve is made from two opposing balls 504 or windows connected by internal spring 505. The spring 505 will keep the windows closed in resting position. Excessive air force will push the balls, stretching the spring, opening the windows for excessive air to escape. When the pressure returns to a level below the set level, the spring will get back to its resting position and close the windows.

The air from the mouthpiece will pass along the conducting tube to the distal end 507. The distal end has a nostril 508 which allows the air to pass freely into the device inlet 217 without any air escape.

In other embodiment, the proximal segment of the blowing tube may be configured to receive air from a portable pump. There are several types of pumps already available in the market. Although pump is not necessary for the function of this device, the manufacture may benefit commercially from supplying a coupling manual pump with the device as an alternative or as an additional option to user's breathing.

Although the description above contain many specifies, these should not be constructed as limiting the scope of the invention but as merely providing illustration of some of the presently preferred embodiments of this invention.

1- A portable device for capturing the energy of moving air inside a spinner to produce electricity comprising:
A hard, hollow freely rotating shaft with plurality of L-shaped hard pipes extending from its hollow space configured to receive an incoming air into its hollow space and to expel the air through narrow offices located in the distal end of the L-shaped pipes,
a toothed wheel coupled to the hollow shaft and coupled to a gear box,
a gear box,
a second high-speed freely rotating solid shaft coupled to the gear box, and to the rotor of an electricity generator,
an electrical regulator to prevent overcharging of the device,
a microprocessor to regulate the device function,
a housing to the above-mentioned components having air inlet, electrical outlets and vents in its walls.

2- The device in claim 1, further comprising an optional power storage such as capacitor and/or a rechargeable battery to store the produced electricity,

3- The device of claim 1, further comprising a coupling blowing tube to deliver air into the device.

4- The tube in in claim 3, comprises a valve to allow escape of air if the pressure inside the tube exceeds a preset level.

5- The tube in claim 3, further comprising internal filter to prevent dust and particles entering the device in claim 1.

6- The tube in claim 3, further comprises a distal section configured to couple to the housing described in claim 1 to create air sealed connection.

7- The tube in claim 3, comprises a proximal section configured to be placed in the user's mouth for inflation.

8- The tube in claim 3, in another embodiment comprises a proximal section configured to be attached to a manual pump for inflation.
